(19) United States
(12) Patent Application Publication
(10) Pub. No.: US 2005/0168861 A1
(43) Pub. Date: Aug. 4, 2005

(54) Method of controlling writing operation in recording disk drive

(75) Inventor: Takao Furuhashi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/902,402

(22) Filed: Jul. 29, 2004

(30) Foreign Application Priority Data
Jan. 30, 2004 (JP) 2004-24537

(51) Int. Cl. G11B 21/02

(52) U.S. Cl. 360/75

(57) ABSTRACT

A head is in general subjected to vibration at the completion of the seek operation due to the inertial force. The head is restrained from writing operation for a predetermined duration after the completion of the seek operation. The head is allowed to start the writing operation after the vibration has sufficiently converged in this manner. The loss of data can reliably be avoided in the adjacent recording track. Moreover, the duration is set unique to the individual head. The duration can be set for the individual heads with a higher accuracy. The duration can thus be reduced to the utmost for the individual heads. The duration of the writing operation can be shortened as compared with a conventional technique.

### BACKGROUND OF THE INVENTION

1. Field of the Invention

The present invention relates to a recording disk drive designed to position a head above a target recording track on a recording disk based on swinging movement of a head actuator.

2. Description of the Prior Art

A head slider and a recording disk often suffer from vibration in a hard disk drive (HDD), forexample. This vibration induces a slight deviation of a write head from the centerline of a recording track in the radial direction of the recording disk. If the deviation exceeds a predetermined allowance, the magnetic field of the write head protrudes beyond a target recording track. Information may be lost in a recording track adjacent the target recording track. When the actual deviation exceeds the allowance, the corresponding track is disused. The allowance is unique to the individual write heads. Accordingly, if the allowance can be set for the individual write heads, the disuse of the recording track can be reduced.

When the write head is instructed to write information, the seek operation is realized to position the write head above a target recording track. A head actuator is allowed to swing about a support shaft in the seek operation. When the seek operation has been changed over to the servo control, the head slider suffers from vibration in the lateral or horizontal direction due to the inertial force.

When the write head conducts writing operation during the vibration of the head slider, the magnetic field of the write head protrudes beyond the target recording track. The information is lost in the recording track adjacent to the target recording track. The write head is refrained from conducting the writing operation, for a predetermined duration after the head actuator has stopped swinging, so as to prevent the protrusion of the magnetic field. In this case, the write head is allowed to start the writing operation after the vibration has reduced. A shortened predetermined duration enables a shorter duration totally required for the writing operation.

### SUMMARY OF THE INVENTION

It is accordingly an object of the present invention to provide a method and program instructions for controlling writing operation in a recording disk drive capable of realizing a shortened duration required for the writing operation.

According to a first aspect of the present invention, there is provided a method of controlling writing operation in a recording disk drive, comprising: conducting seek operation of a head actuator so as to position a head above a target recording track on a recording disk; suspending writing operation of the head for a predetermined duration after completion of the seek operation; and setting the predetermined duration unique to the head in suspending the writing operation of the head.

In general, a head is subjected to vibration at the completion of the seek operation due to the inertial force. If the head suffering from the vibration starts the writing operation, the head inevitably writes data in a recording track adjacent the target recording track. The data should be lost in the adjacent recording track. If the head is restrained from the writing operation for a predetermined duration after the completion of the seek operation, the head is allowed to start the writing operation after the vibration has sufficiently converged or reduced. The loss of data can reliably be avoided in the adjacent recording track.

Moreover, the duration is set unique to the individual head in the aforementioned method. The duration can be set for the individual heads with a higher accuracy. The duration can thus be reduced to the utmost for the individual heads. The duration of the writing operation can be shortened as compared with a conventional technique. If a common duration is set for all heads as conventionally known, an excessive or longer duration is often set for some of the heads. In this case, the write heads often suffer from the restraint of the writing operation for an excessive duration longer than required.

According to a second aspect of the present invention, there is provided a computer-readable storage medium containing program instructions for controlling writing operation in a recording disk drive, comprising: computer program code causing a processor to establish a duration for suspending writing operation of a head subsequent to completion of a seek operation of a head actuator; and computer program code causing the processor to set the duration unique to the head.

When the program instructions are effected, the head is restrained from the writing operation for a predetermined duration after the completion of the seek operation, in the same manner as described above. The head is allowed to start the writing operation after the vibration has sufficiently converged or reduced. In addition, the duration can be reduced to the utmost for the individual head. The duration of the writing operation can be shortened as compared with a conventional technique.

According to a third aspect of the present invention, there is provided a method of controlling writing operation in a recording disk drive, comprising: measuring allowance of a shift of a head deviating from a recording track in the radial direction of a recording disk; and setting a duration unique to the head based on the allowance, said duration being set for suspending writing operation of the head after completion of a seek operation of a head actuator.

The method enables determination of the duration based on the allowance of the shift. Accordingly, the optimal duration can be set for the individual heads. If the head is restrained from the writing operation for the mentioned duration, in the same manner as described above, the writing operation can reliably be shortened in time.

According to a fourth aspect of the present invention, there is provided a computer-readable storage medium containing program instructions for controlling writing operation in a recording disk drive, comprising: computer program code causing a processor to measure allowance of a shift of a head deviating from a recording track in the radial direction of a recording disk; and computer program code causing the processor to set a duration unique to the head based on the allowance, said duration being set for suspending writing operation of the head after completion of a seek operation of a head actuator.

When the program instructions are effected, the duration can be set based on the allowance of the shift in the aforementioned manner. Accordingly, the optimal duration can be set for the individual heads. If the head is restrained from the writing operation for the mentioned duration, in the same manner as described above, the writing operation can reliably be shortened in time.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view schematically illustrating a hard disk drive (HDD) as an example of a magnetic recording medium drive according to the present invention;

FIG. 2 is a plane view schematically illustrating the inner structure of the HDD;

FIG. 3 is a plane view illustrating a part of a magnetic recording in the HDD;

FIG. 4 is a block diagram schematically illustrating the structure of a controlling system of the HDD;

FIG. 5 is a schematic view illustrating the path of a write head along a recording track;

FIG. 6 is a flowchart schematically illustrating the processing of a central processing unit (CPU) for writing of data;

FIG. 7 is a flowchart schematically illustrating the processing of the CPU for setting an allowance according to a specific example;

FIG. 8 is a flowchart schematically illustrating the processing of the CPU for setting an allowance according to another example;

FIG. 9 is a flowchart schematically illustrating the processing of the CPU for setting an allowance according to still another example; and

FIG. 10 is a graph schematically illustrating a correlation between the core width of a write head and the output level of a read signal.

### DESCRIPTION OF THE PREFERRED EMBODIMENT

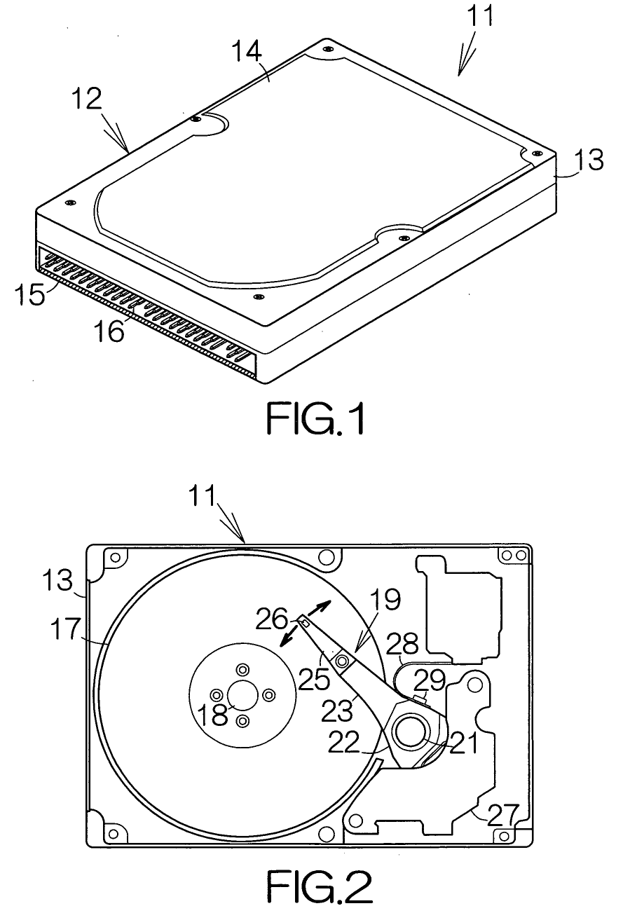

FIG. 1 schematically illustrates a perspective view of a hard disk drive (HDD) 11 as an example of a recording disk drive according to the present invention. The HDD 11 includes a box-shaped enclosure 12. The enclosure 12 includes a box-shaped main enclosure 13 defining an inner space of a flat parallelepiped, for example. The main enclosure 13 may be made from a metal material such as aluminum, for example. Molding process may be employed to form the main enclosure 13. A cover 14 is coupled to the main enclosure 13. The cover 14 serves to define the closed inner space between the main enclosure 13 and the cover 14 itself. Pressing process may be employed to form the cover 14 out of a single metal plate, for example. The plate may be made of a layered material having a property to absorb vibration.

A printed circuit board 15 is attached to the outside of the main enclosure 13. LSI chips, not shown, such as a microprocessor unit (MPU), a hard disk controller (HDC), a read/write channel circuit, a motor driver circuit, and the like, in addition to a buffer memory, not shown, and a connector 16, are mounted on the printed circuit board 15. The LSI chips and the buffer memory will be described later in detail. The MPU and the HDC serve to control the operation of the HDD 11. The connector 16 is designed to receive cables, both not shown, for control signals and power supply extending from a main board of a host computer, for example. The MPU and the HDC are designed to operate based on electric power supplied via the cable for power supply.

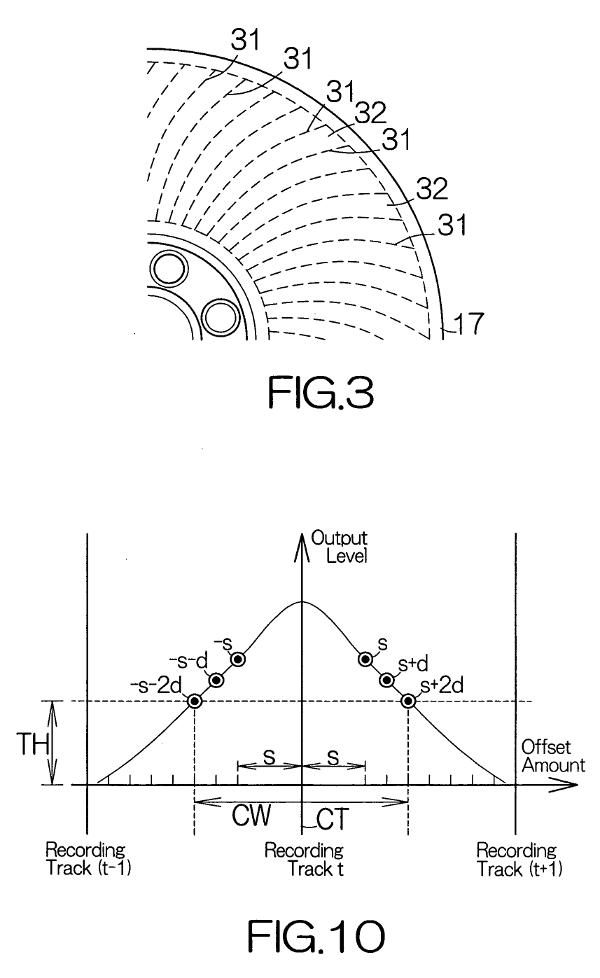

As shown in FIG. 2, at least one magnetic recording disk 17 as a recording medium is contained within the inner space of the main enclosure 13. The magnetic recording disk 17 is mounted on the driving shaft of a spindle motor 18. The spindle motor 18 is allowed to drive the magnetic recording disk 17 for rotation at a higher revolution rate such as 5,400 rpm, 7,200 rpm, 10,000 rpm, or the like.

A head actuator 19 is also contained within the inner space of the main enclosure 13. The head actuator 19 includes an actuator block 22 supported on a vertical support shaft 21 for swinging movement. Rigid actuator arms 23 are defined in the actuator block 22 so as to extend in a horizontal direction from the vertical support shaft 21. A pair of the actuator arm 23 is related to the front and back surfaces of the magnetic recording disk 17. The actuator block 22 may be made from aluminum. Molding process may be utilized to form the actuator block 22.

A head suspension 25 is fixed to the tip end of the individual actuator arm 23. The head suspension 25 extends forward from the tip end of the actuator arm 23. As conventionally known, a flying head slider 26 is cantilevered at the front end of the head suspension 25. The flying head slider 26 is in this manner coupled to the actuator block 22. The flying head slider 26 is thus opposed to the surface of the magnetic recording disk 17.

A magnetic head or electromagnetic transducer, not shown, is mounted on the flying head slider 26. The electromagnetic transducer includes a read head and a write head. The read head may be a giant magnetoresistive (GMR) element or a tunnel-junction magnetoresistive (TMR) element, for example, utilizing variation in the megnetoresistance of a spin valve film or tunnel-junction film to read out information data out of the magnetic recording disk 17. The write head may be a thin film magnetic head designed to utilize a magnetic field induced at a thin film coil pattern so as to write information data into the magnetic recording disk 17.

The head suspension 25 serves to urge the flying head slider 26 toward the surface of the magnetic recording disk 17. When the magnetic recording disk 17 rotates, the flying head slider 26 is allowed to receive airflow generated along the rotating magnetic recording disk 17. The airflow serves to generate a lift on the flying head slider 26. The flying head slider 26 is thus allowed to keep flying above the surface of the magnetic recording disk 17 during the rotation of the magnetic recording disk 17 at a higher stability established by the balance between the lift and the urging force of the head suspension 25.

A driving power source such as a voice coil motor (VCM) 27 is connected to the actuator block 22. The voice coil motor 27 serves to drive the actuator block 22 for rotation around the vertical support shaft 21. The rotation of the actuator block 22 induces the swinging movement of the actuator arms 23 and the head suspensions 25. When the actuator arm 23 swings around the vertical support shaft 21 during the flight of the flying head slider 26, the flying head slider 26 is allowed to move across the surface of the magnetic recording disk 17 in the radial direction of the magnetic recording disk 17. As conventionally known, in the case where two or more magnetic recording disks 17 are incorporated within the inner space of the main enclosure 13, a pair of the actuator arm 23, namely a pair of the head suspension 25, is located between the adjacent magnetic recording disks 17.

A flexible printed circuit board (FPC) 28 is also contained within the inner space of the main enclosure 13. The flexible printed circuit board 28 is electrically connected to the aforementioned printed circuit board 15. One end of the flexible printed circuit board 28 is received on the actuator block 22. The flexible printed circuit board 28 is electrically connected to each of the head suspensions 25 via relay flexible printed circuit boards, not shown, attached to the corresponding actuator arms 23.

A head IC (Integrated Circuit) 29 is mounted on the flexible printed circuit board 28. The head IC 29 is connected to the read/write channel circuit on the printed circuit board 15 through a wiring pattern extending on the flexible printed circuit board 28. The head IC 29 is also connected to the read heads and the write heads on the flying head sliders 26 respectively through the flexible printed circuit board 28, the relay flexible printed circuit boards and wiring patterns extending on the surface of the head suspensions 25.

As shown in FIG. 3, stripes of bent servo sector regions 31, for example, sixty of those, are defined on the front and back surfaces of the magnetic recording disk 17, respectively. The individual servo sector regions 31 are designed to extend in the radial direction of the magnetic recording disk 17. Predetermined servo patterns are established in the servo sector regions 31. The electromagnetic transducer on the flying head slider 26 is allowed to read out magnetic information from the servo patterns. The magnetic information is utilized to position the flying head slider 26 in the radial direction of the magnetic recording disk 17. The curvature of the servo sector region 31 is determined based on the path of movement of the electromagnetic transducer.

Data storage regions 32 are established between the adjacent servo sector regions 31 for holding the magnetic information or binary data. When the flying head slider 26 is positioned in the radial direction of the rotating magnetic recording disk 17, the electromagnetic transducer on the flying head slider 26 is allowed to keep tracing a target recording track. The write head of the electromagnetic transducer operates to establish magnetic bit data on the data storage region 32 along the recording track. Likewise, the read element of the electromagnetic transducer operates to read a string of bit data out of the data storage region 32 along the recording track.

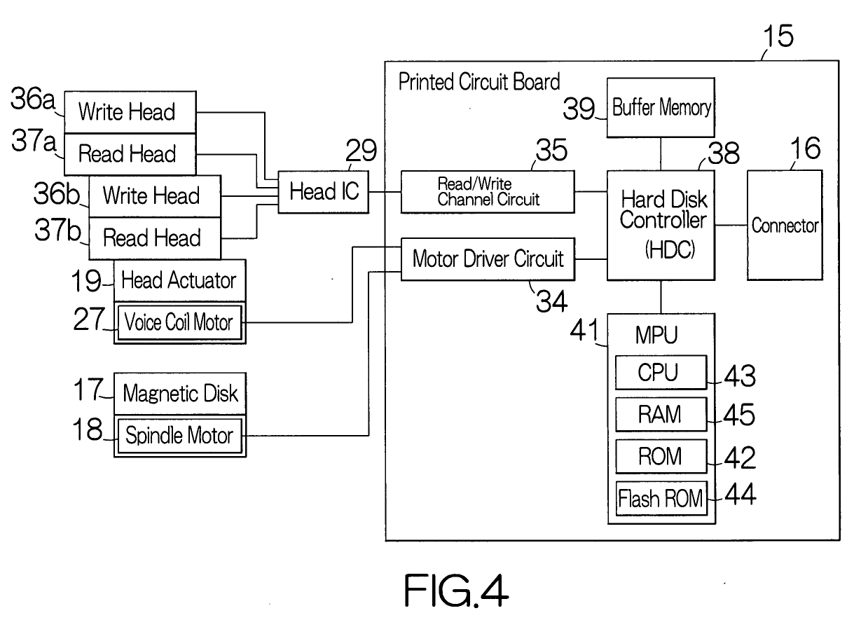

As shown in FIG. 4, the motor driver circuit 34 is connected to the spindle motor 18 and the voice coil motor 27. The motor driver circuit 34 is designed to separately supply the spindle motor 18 and the voice coil motor 27 with driving currents. The spindle motor 18 keeps rotating at a set revolution rate based on the supplied driving current. The voice coil motor 27 is allowed to move by a set amount of movement based on the supplied driving current. The amount of movement is set based on the amount of rotation or angle of the actuator block 22.

The read/write channel circuit 35 is connected to the head IC 29. The read/write channel circuit 35 is designed to encode and decode signals based on a predetermined encoding method. The head IC29 receives an encoded signal, namely, awrite signal. The head IC 29 amplifies the write signal. The amplified write signal is sent to the write heads 36a, 36b. The head IC 29 also amplifies read signals output from the read heads 37a, 37b. The amplified read signals are sent to the read/write channel circuit 35. The read/write channel circuit 35 decodes the read signals.

The HDC 38 is connected to the motor driver circuit 34 and the read/write channel circuit 35. The HDC 38 supplies the motor driver circuit 34 with a control signal. The control signal is utilized to control the output or driving current from the motor driver circuit 34. Likewise, the HDC 38 sends the write signal prior to encoding to the read/write channel circuit 35 and receives the decoded read signal from the read/write channel circuit 35. Data from a host computer may be utilized to generate the write signal prior to encoding at the HDC 38, for example. The date may be transferred through the connector 16 to the HDC 38. Likewise, the HDC 38 restores data based on the decoded read signal. The restored date is sent to the host computer through the connector 16. The HDC 38 is allowed to use a buffer memory 39, for example, so as to realize the transmission and reception of the data. The buffer memory 39 temporarily holds the data. A synchronous dynamic random access memory (SDRAM) may be employed as the buffer memory 39, for example.

The MPU 41 is connected to the HDC 38. The MPU 41 includes a CPU (Central Processing Unit) 43 designed to operate based on programs stored in a read only memory (ROM) 42, for example. The CPU 43 retrieves data from a flash ROM 44, for example, so as to accomplish the operation. These data and programs may temporarily be stored in a random access memory (RAM) 45. The ROM 42, the flash ROM 44 and the RAM 45 are directly connected to the CPU 43.

When the write head 36a stands in the writing operation, the write head 36a keeps following the magnetic recording track according to a so-called servo control. A positional signal is generated from the read head 37a based on the servo patterns on the magnetic recording disk 17. The positional signal is amplified at the head IC 29. The amplified signal is then transferred through the read/write channel circuit 35 to the HDC 38. The HDC 38 determines the control quantity of the voice coil motor 27 based on the amplified positional signal. The motor driver circuit 34 supplies the voice coil motor 27 with a driving current based on a control signal supplied from the HDC 38. Deviation of the write head 36a in the radial direction, namely, offset can in this manner be canceled based on the positional signal.

As shown in FIG. 5, the write head 36a usually suffers from a slight shift or deviation from the centerline CT of a recording track in the radial direction of the magnetic recording disk 17 during the servo control. Vibration of the flying head slider 26 and/or the magnetic recording disk 17 and other factors may cause the shift of the write head 36a. If the amount of the shift exceeds a predetermined allowance or permissible range, the magnetic field of the write head 36a protrudes from a target recording track. Information data may be lost in the adjacent recording track. In this case, the CPU 43 calculates the amount of the shift of the write head 36a in the radial direction of the magnetic recording disk 17, namely, the offset amount sbased on the positional signal. As is apparent from FIG. 5, the offset amount s is defined as a distance between the centerline CT of a recording track and the centerline CH of the write head 36a, for example. The calculated offset amount s, namely, a measurement value is compared with the allowance p inherent or unique to the write head 36a. If the measurement value of the offset amount s exceeds the allowance p, the CPU 43 forces the write head 36a to refrain from the writing operation. As a result, information data is prevented from being lost in the adjacent recording track. If the write head 36a continues the writing operation even after the measurement value of the offset amount s exceeds the allowance p, the magnetic field of the write head 36a often acts on the adjacent recording track at a sufficient intensity. The adjacent recording track is thus overwritten. Data could be lost in the adjacent recording track.

In general, the write heads 36a, 36b, . . . have core widths slightly different from one another because of tolerance and other factors. The individual write heads 36a, 36b, . . . thus establish the magnetic fields having different distributions of intensity. Accordingly, the write heads 36a, 36b, . . . have different allowances of deviation or shift. The aforementioned HDD 11 enables the setting of the allowance p inherent or unique to the individual write head 36a, 36b, . . . , respectively, as described later in detail, so that the allowance p can be set at a higher accuracy for the individual write head 36a, 36b, . . . , respectively. The restraint of the writing operation can be avoided as compared with a conventional HDD. To the contrary, if a common allowance p is set for all the write heads 36a, 36b, . . . , as conventionally known, an excessive or wider allowance p is often set for some write heads. In this case, the writing operation of the write heads is excessively refrained.

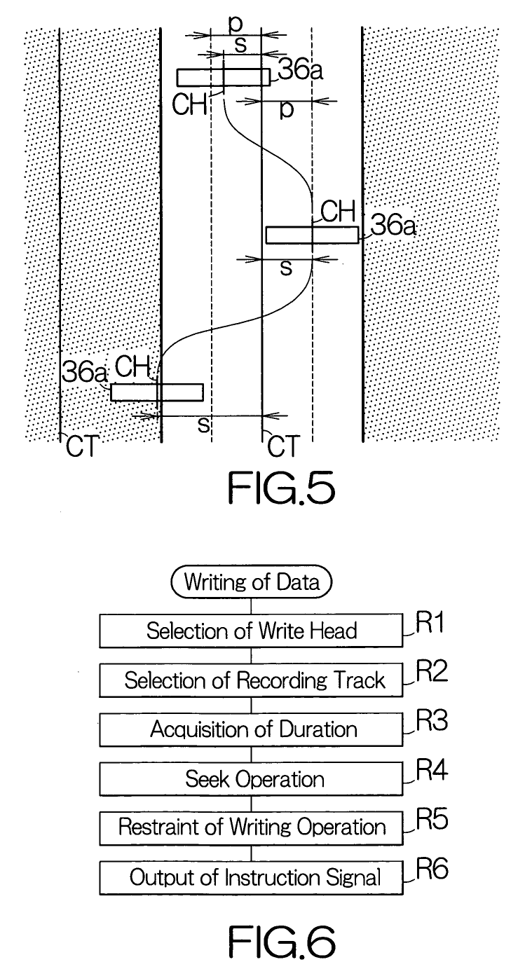

Assume that data is to be written into the magnetic recording disk 17. The CPU 43 selects any one of the write heads, the write head 36a for example, at step R1, as shown in FIG. 6. The selection of the write head 36a leads to inevitable selection of a surface of the magnetic recording disk 17. The CPU 43 subsequently selects a target recording track on the surface of the magnetic recording disk 17 at step R2. The CPU 43 then obtains a predetermined duration inherent or unique to the selected write head 36a at step R3. Here, the CPU 43 retrieves duration time data from the flash ROM 44. The flash ROM 44 holds duration time data unique to the individual write heads 36a, 36b, . . . , respectively. The duration time data may include time values corresponding to the individual durations.

At step R4, the CPU 43 outputs an instruction signal for seek operation. The instruction signal includes designation of a track number of the target recording track and a sector number, for example. The instruction signal is sent to the HDC 38. The HDC 38 supplies the motor driver circuit 34 with the control signal based on the instruction signal. The control signal includes the controlling quantity determining the amount of the swinging movement of the head actuator 19. The voice coil motor 27 in this manner receives a predetermined driving current. The head actuator 19 swings by the amount designated by the control signal.

The CPU 43 keeps monitoring the offset amount s of the write head 36a during the seek operation. The CPU 43 recognizes the completion of the seek operation, when the offset amount s stays below the allowance p as to the target recording track. The positioning of the write head 36a is thus completed. The CPU 43 then sets restraint of the writing operation for the write head 36a at step R5. Specifically, the write head 36a is refrained from the writing operation. The date may be buffered in the buffer memory 39, for example. The restraint of the writing operation is canceled when the aforementioned duration has elapsed after the completion of the positioning, namely, the completion of the seek operation. The CPU 43 thereafter outputs the instruction signal for writing operation at step R6. The HDC 38 sequentially transfers the data to the read/write channel circuit 35 from the buffer memory 39. A write current is supplied to the write head 36a based on the data. A magnetic filed is generated at the write head 36a in response to the supply of the write current.

The head actuator 19 swings over a relatively wider range during the seek operation. The head actuator 19 swings over a slight range during the servo control subsequent to the seek operation. The swinging movement of the head actuator 19 is rapidly restricted at the completion of the seek operation. The inertial force thus induces a lateral vibration or repetitive shift of the flying head slider 26. As described above, the serve sector regions 31 and the data storage regions 32 are alternately arranged on the magnetic recording disk 17. The offset amount s of the write head 36a can be measured above the servo sector regions 31 with a high accuracy. The write head 36a thus follows the recording track at a higher accuracy based on the measured offset amount s. The write head 36a is accordingly subjected to less influence of the vibration. On the other hand, the HDC 38 cannot obtain the positional signal all over the data storage regions 32. The write head 36a cannot enjoy a sufficient influence of the servo control above the data storage regions 32. The influence of the vibration cannot sufficiently be eliminated. If the write head 36a starts the writing operation during the vibration of the flying head slider 26, the magnetic filed of the write head 36a protrudes beyond the target recording track in the data storage region 32. Data is lost in the recording track or tracks adjacent the target recording track. The setting of the aforementioned duration reliably enables the writing operation of the write heads 36a, 36b, . . . exactly after the convergence of the vibration. Data is reliably prevented from being lost in the adjacent recording track.

Furthermore, the duration is set for the individual write heads 36a, 36b, . . . in the aforementioned HDD 11, as described laterindetail. Thedurationcanbesetuniquetotheindividual write head 36a, 36b, . . . at a higher accuracy. The duration can thus be reduced to the utmost for the individual write heads 36a, 36b, . . . . The duration of the writing operation can be shortened as compared with a conventional HDD. If a common duration is set for all the write heads 36a, 36b, . . . , as conventionally known, an excessive or longer duration is often set for some of the write heads 36a, 36b, . . . . In this case, the write heads 36a, 36b, . . . often suffer from the restraint of the writing operation for an excessive duration longer than required.

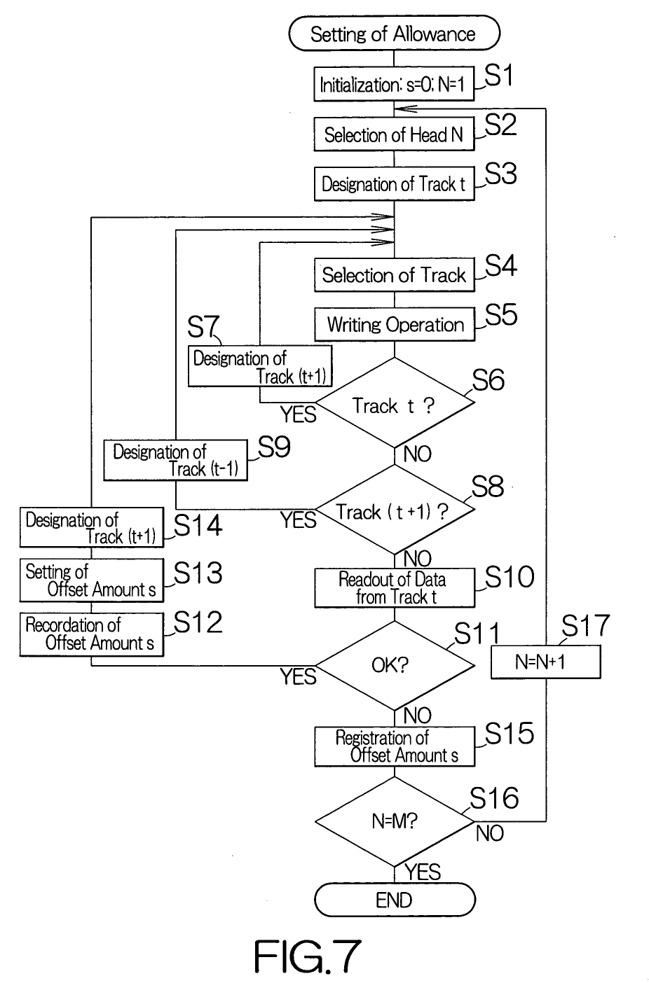

Here, the CPU 43 may operate to set the allowance p, for example. As shown in FIG. 7, the CPU 43 initializes variables s and N at step S1. The setting of value “1” for the variable N leads to selection of the first write head 36a at step S2. The CPU 43 designates a recording track on the magnetic recording disk 17 at step S3. The track number t may be utilized to designate the recording track. The CPU 43 selects at step S4 the recording track of the track number t as a target recording track on which the write head 36a effects the writing operation.

The CPU 43 outputs an instruction signal for writing data at step S5. The HDC 38 sends the control signal to the motor driver circuit 34 in response to the supply of the instruction signal. The supply of the control signal induces the supply of the driving current to the voice coil motor 27 from the motor driver circuit 34. The voice coil motor 27 drives the head actuator 19 for swinging movement around the vertical support shaft 21. The write head 36a is thus positioned above the recording track of the track number t. The write head 36a thereafter keeps following the recording track with the assistance of the serve control.

The CPU 43 sends a string of data to the write head 36a while the write head 36a follows the recording track. The data may previously be stored in the flash ROM 44, for example. The HDC 38 transfers the data to the read/write channel circuit 35 at a predetermined timing. The data is in this manner written into the recording track of the track number t.

The CPU 43 checks the target recording track at step S6. If the track number t is recognized, the processing of the CPU 43 proceeds to step S7. The CPU 43 designates a recording track specified by the track number (t+1). This recording track extends adjacent the recording track of the track number t outside the recording track of the track number t. The processing of the CPU 43 thereafter returns to step S4. The CPU 43 selects the recording track of the track number (t+1) as the next target recording track. The CPU 43 subsequently allows the write head 36a to conduct the writing operation at step S5. A noise signal is this time written into the recording track of the track number (t+1).

When the writing operation has been completed, the CPU 43 checks the target recording track at steps S6 and S8. If the track number (t+1) is recognized, the processing of the CPU 43 proceeds to step S9. The CPU 43 designates a recording track specified by the track number (t−1) this time. This recording track extends adjacent the recording track of the track number t inside the recording track of the track number t. The processing of the CPU 43 then returns to step S4. The CPU 43 selects the recording track of the track number (t−1) as the next target recording track. The CPU 43 allows the write head 36a to conduct the writing operation. A noise signal is written into the recording track of the track number (t−1).

When the writing operation has been completed in connection with the recording tracks of the track number t, (t+1) and (t−1), the processing of the CPU 43 proceeds to step S10. The CPU 43 allows the read head to read out data from the recording track of the track number t at step S10. The CPU 43 outputs an instruction signal for reading data. The read head 37a is positioned above the recording track of the track number t in response to the output of the instruction signal. The servo control serves to force the read head 37a to follow the recording track. The CPU 43 judges at step S11 whether or not the data has correctly been read out from the recording track of the track number t. The data may be compared with the original data stored in the flash ROM 44, for example.

If the data has correctly been read out from the recording track, the processing of the CPU 43 proceeds to step S12. The CPU 43 stores the offset amount s=0. The offset amount s=0 may temporarily be stored in the RAM 45, for example. The CPU 43 then changes the offset amount s at step S13. Here, the CPU 43 adds a predetermined increment d to the current offset amount s. A new offset amount s is set in this manner. The CPU 43 then designates the recording track of the track number (t+1) again at step S14. A noise signal is written into the recording track of the track number (t+1) at steps S4 and S5 in the same manner as described above. In this case, the path of the write head 36a is shifted inside from the centerline of the recording track of the track number (t+1) by the amount corresponding to the increment d. Specifically, the path of the write head 36a shifts toward the recording track of the track number t by the amount corresponding to the increment d. The recording track of the noise signal moves toward the recording track of the track number t by the amount corresponding to the increment d.

The CPU 43 thereafter designates the recording track of the track number (t−1) again at steps S8 and S9. A noise signal is written into the recording track of the track number (t−1) in the same manner as described above. In this case, the path of the write head 36a is shifted outside from the centerline of the recording track of the track number (t−1) by the amount corresponding to the increment d. The path of the write head 36a thus moves toward the recording track of the track number t by the amount corresponding to the increment d. The recording track of the noise signal moves toward the recording track of the track number t by the amount corresponding to the increment d.

When the writing operation of the write head 36a has been completed in this manner in connection with the recording tracks of the track number (t+1) and (t−1), the processing of CPU 43 proceeds to step S10. The CPU 43 allows the read head 37a to read out data from the recording track of the track number t at step 10. The CPU 43 judges whether or not the data has correctly been read out from the recording track of the track number t at step 11. When the data has correctly been read out from the recording track, the processing of the CPU 43 proceeds to step S12. The current offset amounts is recorded. The CPU 43 changes again the offset amount s at step S13.

On the other hand, when a defect is found in the data, the processing of the CPU 43 proceeds to step S15. The CPU 43 registers the recorded offset amount s. The offset amount s may be stored in the flash ROM 44. The registered offset amount s corresponds to an allowance p inherent or unique to the write head 36a. The CPU 43 judges whether or not the offset amount s is measured for all of the write heads 36a, 36b, . . . at step S16. If the variable N, utilized to count the write heads 36a, 36b, . . . , is found equal to the number M expressing the number of the write heads 36a, 36b, . . . , the CPU 43 finishes the processing. If the variable N is below the number M, the processing of the CPU 43 proceeds to step S17. In this case, the processing of the CPU 43 proceeds to step S2, so that the next write head 36b is selected. All the write heads 36a, 36b, . . . are sequentially selected one by one. The allowances p are in this manner set for the individual write heads 36a, 36b, . . . .

When the allowances p of the offset amount have been set for the respective write heads 36a, 36b, . . . , the CPU 43 determines the aforementioned duration for the individual write heads 36a, 36b, . . . based on the allowance p of the offset amount. The duration can be determined based on a certain correlation between the duration and the allowance p, for example. The correlation may be derived from actual measurement. Otherwise, the duration may be modified or adjusted in accordance with the speed of the moving flying head slider 26, the distance of the movement, and/or the like. The determined duration is stored in the flash ROM 44.

After the allowances p have been set, the CPU 43 calculates measurement values of the offset amount s for the respective recording tracks. The calculated measurement values are compared with the allowances p of the respective write heads 36a, 36b, . . . . When the measurement value of the offset amount s exceeds the allowance p, the CPU 43 registers the track number of the corresponding recording track in the flash ROM 44, for example.

The above comparison between the measurement values and the allowances p may be conducted in a factory prior to the shipment of products. After this comparison has been completed, the track number stored in the flash ROM 44 is taken out from the HDD 11. A host computer may be connected to the HDD 11 so as to take out the track number. If no track number can be taken out from the flash ROM 44, the HDD 11 is recognized as a product for shipment. In the case where the measurement value of offset amount s exceeds the allowance p as described above, the magnetic field of the write head 36a, 36b, . . . acts on the adjacent recording track at a sufficient intensity when the writing operation of the write head 36a, 36b, . . . is effected in connection with the target recording track. The adjacent recording track should be rewritten. Data should be lost in the adjacent recording track. The recording track of the type should thus preferably be left unused.

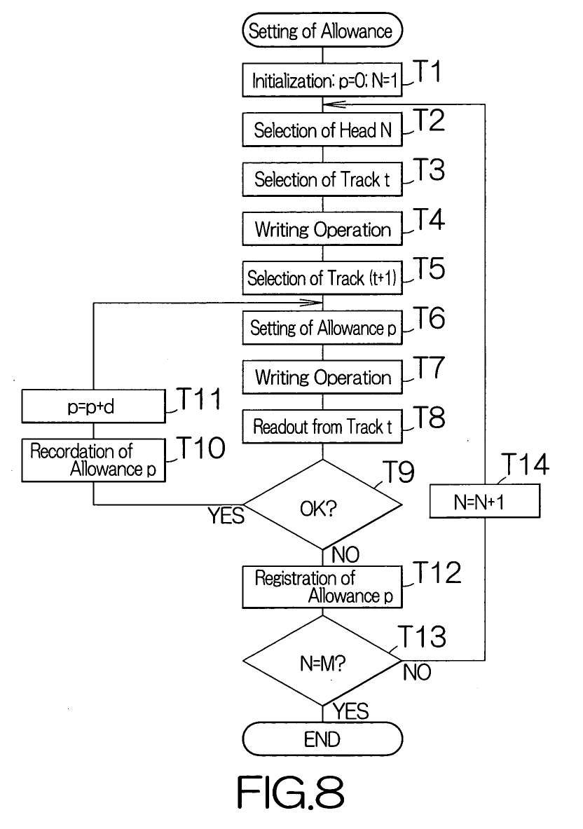

Other processing may be employed in the CPU 43 so as to determine the allowance p of the offset amount, as shown in FIG. 8, for example. The CPU 43 initializes variables p and N at step T1. The setting of (N=1) leads to selection of the first write head 36a at step T2. The CPU 43 designates a recording track on the magnetic recording disk 17 at step T3. The track number t may be utilized to designate the recording track. The CPU 43 allows the write head 36a to write data into the recording track of the track number t at step T4. The CPU 43 outputs an instruction signal for writing data, in the same manner as described above.

The CPU 43 then selects a recording track specified by the track number (t+1) at step T5. This recording track extends adjacent the recording track of the track number t outside the recording track of the track number t. The CPU 43 sets an allowance p of the offset amount at step T6. The allowance p may have an arbitrary value. The CPU 43 allows the write head 36a to write data into the recording track of the track number (t+1) at step T7. The CPU 43 outputs an instruction signal for writing data in the same manner as describe above. In this case, the write head 36a is forcedly subjected to vibration in the radial direction of the magnetic recording disk 17. The amplitude of the vibration, namely, the offset amount s is kept within the allowance p. The CPU 43 operates to prevent the write head 36a from effecting the writing operation if the measurement value of the offset amount s exceeds the allowance p as described above.

The CPU 43 allows the read head 37a to read out data from the recording track of the track number t at step T8. The CPU 43 judges whether or not the data has correctly been read out from the recording track of the track number t at step T9. If the data has correctly been read out from the recording track, the processing of the CPU 43 proceeds to step T10. The CPU 43 records the current allowance p. The CPU 43 then adds a predetermined increment d to the allowance p at step T11. A new allowance p is set in this manner. The data is written into the recording track of the track number (t+1) based on the new allowance p at steps T6 and T7 in the same manner as described above. Here, the write head 36a is forcedly subjected to vibration in the radial direction of the magnetic recording disk 17 within the set allowance p. Specifically, the offset amount s gets increased.

The CPU 43 thereafter judges whether or not the data has correctly been read out from the recording track of the track number t at steps T8 and T9. If the data has correctly been read out from the recording track, the CPU 43 records the current allowance p as described above. If a defect is found in the data, the processing of the CPU 43 proceeds to step T12. The CPU 43 registers the former allowance p. The allowance p may be stored in the flash ROM 44, for example. The CPU 43 judges whether or not the allowance p is set for all the write heads 36a, 36b, . . . at step T13. The allowance p is sequentially set for all the write heads 36a, 36b, . . . in accordance with the processing at steps T13 and T14.

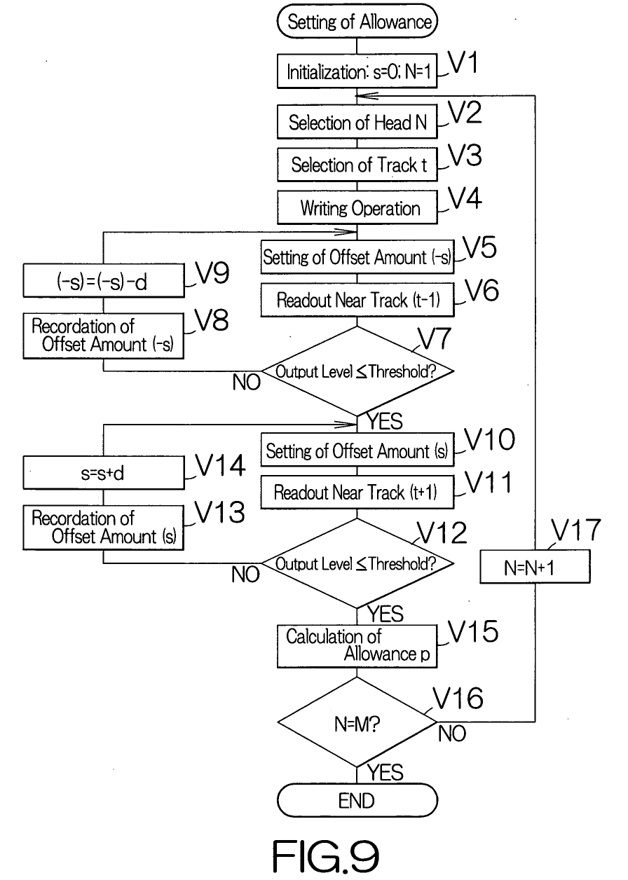

The CPU 43 may set the allowance for the respective write heads 36a, 36b, . . . based on measurement of the core widths CW. In this case, the CPU 43 initializes variables s and N at step V1 as shown in FIG. 9., for example. The setting of (N=1) leads to selection of the first write head 36a at step V2. The CPU 43 designates a recording track on the recording disk 17 at step V3. The track number t may be utilized to designate the recording track. The CPU 43 then allows the write head 36a to write data into the recording track of the track number t at step V4. The CPU 43 outputs an instruction signal for writing data as described above.

The CPU 43 sets the offset amount (−s) at step V5. The CPU 43 reads out data from the recording track of the track number t based on the offset amount (−s) at step V6. In this case, the read head 37a shifts toward the recording track of the track number (t−1) based on the offset amount (−s). Specifically, the path of the read head 37a shifts inside by the offset amount (−s).

The CPU 43 compares the output level of the read signal with a predetermined threshold TH at step V7. If the output level exceeds the predetermined threshold TH, the CPU 43 records the current offset amount (−s) at step V8. The CPU 43 then sets a new offset amount (−s) at step V9. Since a predetermined increment d is subtracted from the former offset amount (−s), the absolute value of the resulting offset amount (−s) gets increased. The processing of the CPU 43 thereafter returns to step V5. The path of the read head 37a is stepwise shifted toward the recording track of the track number (t−1) until the output level of the read signal becomes equal to or smaller than the predetermined threshold TH at step V7.

If the output level of the read signal becomes equal to or smaller than the predetermined threshold TH at step V7, the CPU 43 sets an offset amount s this time at step V10. The CPU 43 allows the read head 37a to read out data from the recording track of the track number t based on the set offset amount s at step V11. The read head 37a this time shifts toward the recording track of the track number (t+1) based on the offset amount s. Specifically, the path of the read head 37a shifts outside by the offset amount s. The CPU 43 compares the output level of the read signal with the predetermined threshold TH at step V12. If the output level of the read signal exceeds the predetermined threshold TH, the CPU 43 records the current offset amount s at step V13. The CPU 43 then sets a new offset amount s at step V14. A predetermined increment d is added to the former offset amount s. The processing of the CPU 43 then returns to step V10. The path of the read head 37a is stepwise shifted toward the recording track of the track number (t+1) until the output level of the read signal becomes equal to or smaller than the predetermined threshold TH at step V12.

When the offset amounts s and (−s) have been obtained, the CPU 43 calculates the allowance p at step V15. The CPU 43 judges at step V16 whether or not the allowance p has been calculated for all the write heads 36a , 36b, . . . . The allowance p are sequentially set for all the write heads 36a, 36b, . . . respectively based on the processing at steps V16 and V17.

In general, a correlation can be observed between the output level PW of the read signal and the core width CW of the write head 36a, 36b, . . . , as is apparent from FIG. 10. The remoter from the centerline CT of a recording track the read head 37a, 37b, . . . gets, the smaller the output level PW of the read signal becomes. Accordingly, the threshold TH of the output level PW can be a representation of the core width CW of the write head 36a, 36b, . . . . If a certain correlation is recognized between the output level PW of the read head 37a, 37b, . . . and the intensity of the magnetic field contributing to the establishment of data on the magnetic recording disk 17, for example, the allowance p of the offset amount is directly derived from the threshold TH.

1. A method of controlling writing operation in a recording disk drive, comprising:
conducting seek operation of a head actuator so as to position a head above a target recording track on a recording disk;
suspending writing operation of the head for a predetermined duration after completion of the seek operation; and
setting the predetermined duration unique to the head in suspending the writing operation of the head.

2. A computer-readable storage medium containing program instructions for controlling writing operation in a recording disk drive, comprising:
computer program code causing a processor to establish a duration for suspending writing operation of a head subsequent to completion of a seek operation of a head actuator; and
computer program code causing the processor to set the duration unique to the head.

3. Amethod of controlling writing operation ina recording disk drive, comprising:
measuring allowance of a shift of a head deviating from a recording track in a radial direction of a recording disk; and
setting a duration unique to the head based on the allowance, said duration being set for suspending writing operation of the head after completion of a seek operation of a head actuator.

4. A computer-readable storage medium containing program instructions for controlling writing operation in a recording disk drive, comprising:
computer program code causing a processor to measure allowance of a shift of a head deviating from a recording track in a radial direction of a recording disk; and
computer program code causing the processor to set a duration unique to the head based on the allowance, said duration being set for suspending writing operation of the head after completion of a seek operation of a head actuator.
